(19) United States
(12) Patent Application Publication
(10) Pub. No.: US 2008/0061926 A1
(43) Pub. Date: Mar. 13, 2008

(54) Method and apparatus for utilizing a transmitter having a range limitation to control a movable barrier operator

(75) Inventor: Larry Strait, Glen Ellyn, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc., Elmhurst, IL (US)

(21) Appl. No.: 11/496,363

(22) Filed: Jul. 31, 2006

(51) Int. Cl. H04L 9/32

(52) U.S. Cl. 340/5.22; 340/5.26; 340/5.7; 340/5.71; 340/5.64; 340/5.61

(57) ABSTRACT

A system commands a movable barrier operator to control movement of a movable barrier and perform additional movable barrier functions. An identification transmitter wirelessly transmits an identification signal, where the identification signal comprises a code. A primary transmitter stores at least one vehicle identification code corresponding to a specific vehicle and receives a request to transmit a wireless control signal to the movable barrier operator to command the movable barrier operator to perform the at least one of the additional movable barrier functions. The primary transmitter also transmits the wireless control signal in response to receiving the request, detecting the identification signal, and determining that the code of the identification signal matches the at least one vehicle identification code.

### TECHNICAL FIELD

This invention relates generally to RF transmitters, and more particularly to an RF transmitter for use with a movable barrier operator that is only operable within a predetermined distance from an identification transmitter.

### BACKGROUND

Various remotely controllable access control mechanisms are known, including barrier movement operators for movable barriers including, but not limited to, single and segmented garage doors, pivoting and sliding doors and cross-arms, rolling shutters, and the like. In general, each such system includes a primary barrier control mechanism. The latter couples, in an appropriate way, to a corresponding barrier and causes the barrier to move (typically between closed and opened positions).

A Radio Frequency (“RF”) transmitter is typically utilized to remotely control a garage door opener for opening and closing a garage door. The RF transmitter is often physically located within an automobile and an RF control signal may be transmitted to the garage door opener in response to, for example, pressing a button on the RF transmitter.

A problem arises, however, in the event that the RF transmitter is stolen. A stolen RF transmitter could be utilized to control the garage door opener to gain access to a garage, and a thief might be able to steal items within the garage such as expensive tools or automobiles. There is currently no limitation on who uses the RF transmitter. That is, when a button on a RF transmitter is depressed, the RF transmitter transmits a signal to the barrier movement operator regardless of who depressed the button. This is especially problematic because many homeowners do not lock a door in the garage leading directly into the house. Therefore, not only would valuables inside of the garage itself be vulnerable in the event an RF transmitter of a current system is lost or stolen, valuables stored inside of the house would also be vulnerable.

Current RF transmitters function normally when located outside of an automobile. For example, in the event that the vehicle is one hundred miles away while the user is on vacation, a stolen RF transmitter can currently be used to gain access to the garage. There is therefore no limitation on how far away current transmitters can be removed from the inside of the automobiles in which they are typically utilized and stored.

### SUMMARY OF THE INVENTION

The present invention is directed to a method for commanding a movable barrier operator to control movement of a movable barrier and perform additional movable barrier functions. A learning mode indication is received to implement a learning mode. The learning mode comprises receiving and storing a vehicle identification code corresponding to a specific vehicle. A request is received to transmit a control signal to the movable barrier operator to command the movable barrier operator to perform at least one of the additional movable barrier functions. An identification signal wirelessly transmitted is detected at a predetermined rate from a predetermined device. A determination is made as to whether the identification signal comprises a code matching the vehicle identification code. Finally, the control signal is transmitted to the movable barrier operator to command the movable barrier operator to perform the at least one of the additional movable barrier functions in response to the receiving, the detecting, and the determining that the identification signal comprises the code matching the vehicle identification code. The predetermined device may comprise a transmitter within a vehicle or a portable transmitter that can be carried by a user outside of a vehicle.

The present invention is further directed to a system for commanding a movable barrier operator to control movement of a movable barrier and perform additional movable barrier functions. An identification transmitter wirelessly transmits an identification signal, where the identification signal comprises a code. A primary transmitter stores at least one vehicle identification code corresponding to a specific vehicle and receives a request to transmit a wireless control signal to the movable barrier operator to command the movable barrier operator to perform the at least one of the additional movable barrier functions. The primary transmitter also transmits the wireless control signal in response to receiving the request, detecting the identification signal, and determining that the code of the identification signal matches the at least one vehicle identification code. The identification transmitter may comprise a transmitter within a vehicle or a portable transmitter that can be carried by a user outside of a vehicle.

The present invention is also directed to a primary transmitter for commanding a movable barrier operator to control movement of a movable barrier and perform additional movable barrier functions. An input element receives an input from a user to command the movable barrier operator. A memory stores at least one vehicle identification code corresponding to a specific vehicle. A transceiver transmits a wireless control signal to the movable barrier operator to command the movable barrier operator to perform the at least one of the additional movable barrier functions in response to detecting a wireless identification signal transmitted from a predetermined device, and in response to determining that the wireless identification signal comprises a code matching the at least one vehicle identification code. A processor controls operation of the transceiver in response to receiving the input from the input element. The predetermined device may comprise a transmitter within a vehicle or a portable transmitter that can be carried by a user outside of a vehicle.

The present invention is further directed to a kit having an identification transmitter to wirelessly transmit an identification signal. The identification signal comprises a code. The kit also has a primary transmitter to store at least one vehicle identification code corresponding to a specific vehicle, receive a request to transmit a wireless control signal to a movable barrier operator to command the movable barrier operator to perform the at least one movable barrier function, and to transmit a wireless control signal in response to receiving the request, detecting the identification signal, and determining that the code of the identification signal matches the at least one vehicle identification code. A set of instructions is included that instructs as to how to use the identification transmitter and the primary transmitter.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above needs are at least partially met through provision of the method and apparatus for remote control described in the following detailed description, particularly when studied in conjunction with the drawings, wherein:

FIG. 1 is a perspective view of a garage including a barrier movement operator, specifically a garage door operator, having associated with it a passive infrared detector in a wall control unit and embodying the present invention;

FIG. 2 is a block diagram showing the relationship between major electrical systems of a portion of the garage door operator shown in FIG. 1;

FIG. 3 illustrates a remote access system according to at least one embodiment of the invention;

FIG. 4 illustrates a learning process for associating the primary transmitter with the vehicle according to at least one embodiment of the invention

FIG. 5 illustrates a method of utilizing a secondary transmitter to provide an identification signal to a primary transmitter to transmit RF signals to a garage door opener according to at least one embodiment of the invention;

FIG. 6 illustrates a primary transmitter according to at least one embodiment of the invention;

FIG. 7 illustrates a remote access system according to at least one embodiment of the invention;

FIG. 8 illustrates a method of utilizing the primary transmitter according at least one embodiment of the invention;

FIG. 9 illustrates a Radio Frequency Identifier (“RFID”) device according to at least one embodiment of the invention;

FIG. 10 illustrates a system for utilizing a secondary transmitter to provide an identification signal to a primary transmitter to transmit RF signals to a garage door opener according to at least one embodiment of the invention; and

FIG. 11 illustrates a kit according to at least one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, an RF transmitter is provided for controlling operation of a barrier movement operator, such as a garage door opener. The ability of the RF transmitter to function when it is distant from a vehicle in which is normally used is, however, limited. In other words, if the RF transmitter is too far away from the vehicle, the RF transmitter will not function to transmit an RF signal to a garage door opener to cause a garage door to open and close. For example, the optimal distance may be 10-30 feet depending on the embodiment. Alternatively, the RF transmitter may be adapted to function only within a certain proximity of some object other than a vehicle, such as, for example, a Radio Frequency Identifier (“RFID”) card within a user's wallet or coupled to a keychain. This distance restriction is implemented for safety purposes so that in the event that, for example, the RF transmitter is stolen or lost, it cannot be used to cause the garage door opener to open the garage door by a third party. Because it is known someone either within or near the vehicle will normally use the RF transmitter, this restriction is made and may be used to prevent unauthorized usage.

In an embodiment, a secondary RF transmitter may be placed within the vehicle and may periodically broadcast an identification signal. If the primary RF transmitter receives the identification signal, it is subsequently allowed to transmit an RF signal to the garage door opener to open or close the garage door. In some embodiments, the primary RF transmitter cannot transmit an RF signal unless it has received the identification signal within a predetermined time period. In other embodiments, the primary RF transmitter can still transmit the RF signal regardless of whether the identification signal has been received from the secondary transmitter. However, in order to operate, the garage door operator would need to receive a certain code from the primary RF transmitter. This code may be received from the secondary RF transmitter via the identification signal. In this embodiment, the secondary RF transmitter is located with the vehicle. For example, it may be stored separately from the primary RF transmitter, for example, in a glove box, on visor, or anywhere else in the vehicle. In some embodiments, the secondary RF transmitter is permanently fixed in the vehicle. In other embodiments, the secondary RF transmitter is movable. In embodiments where the secondary RF transmitter is fixed inside the vehicle, the secondary RF transmitter may be mounted onto the dashboard or to an armrest or fixedly mounted at any other suitable place in the vehicle. The identification signal may include a rolling or fixed code. In some embodiments, an RF signal must be transmitted to the garage door opener within a predetermined time limit (such as 60 seconds) or the primary RF transmitted will wait until it receives a new identification signal from the secondary transmitter prior to transmitting the RF signal to the garage door opener.

The primary RF transmitter may be associated with a specific vehicle. The association may be made when the vehicle is manufactured. Alternatively, a learning process may be implemented to make this association. During the learning process, a vehicle identification code may be received from the secondary transmitter and stored in a memory of the primary transmitter. After the learning process is completed, the primary transmitter may be controlled so that an RF signal is transmitted to the garage door opener only after a signal containing the same vehicle identification code has been received from the secondary transmitter.

In another embodiment, a RFID device may be utilized. In such embodiments, instead of intermittently broadcasting the identification signal at certain intervals, the identification signal may instead be transmitted via RFID technology. For example, a user may depress a button on the RF transmitter, causing an RF signal to be transmitted to the RFID device. Upon receiving the RF signal, the RFID device transmits the identification signal to the RF transmitter. In some embodiments, the RFID tag is in communication with a transmitter and utilizes power from the received signal to transmit the identification signal. In other embodiments, the transmitter receives power from a battery or other power source to transmit the identification signal.

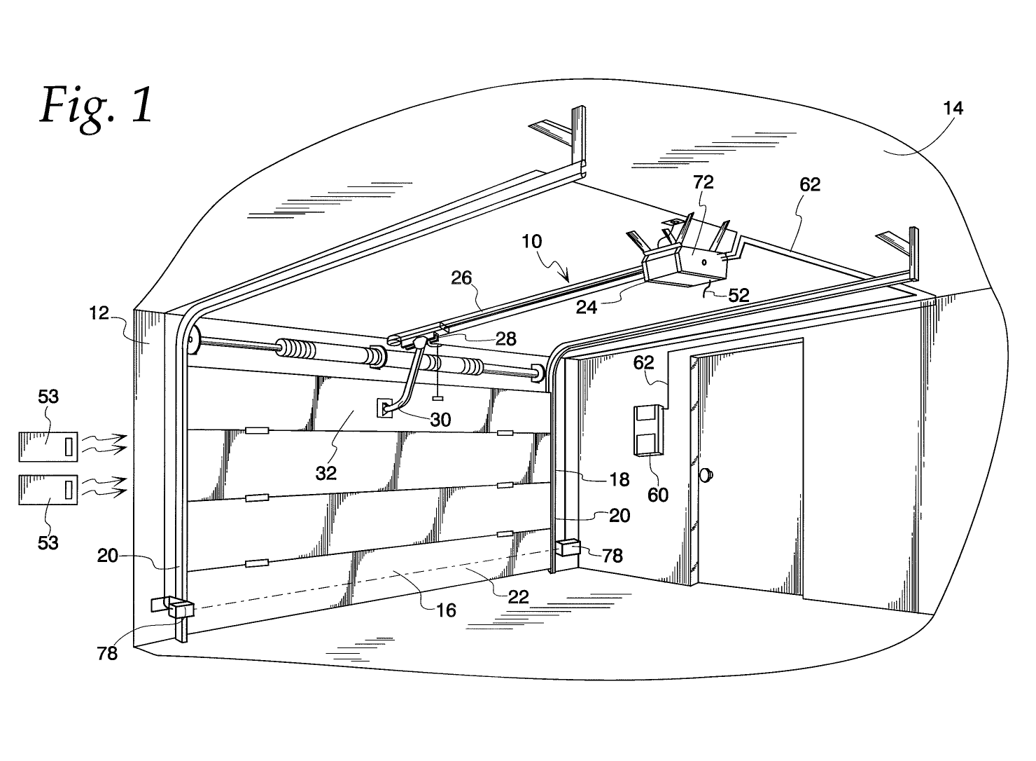

Referring now to drawings and especially to FIG. 1, a barrier movement operator embodying the present invention is shown therein and generally identified by reference numeral 10. The barrier movement operator, in this embodiment a garage door operator 10, is positioned within a garage 12. More specifically, it is mounted to a ceiling 14 of the garage 12 for operation, in this embodiment, of a multipanel garage door 16. The multipanel garage door 16 includes a plurality of rollers 18 rotatably confined within a pair of tracks 20 positioned adjacent to and on opposite sides of an opening 22 for the garage door 16.

The garage door operator 10 also includes a head unit 24 for providing motion to the garage door 16 via a rail assembly 26. The rail assembly 26 includes a trolley 28 for releasable connection of the head unit 24 to the garage door 16 via an arm 30. The arm 30 is connected to an upper portion 32 of the garage door 16 for opening and closing it. The trolley 28 is connected to an endless chain to be driven thereby. The chain is driven by a sprocket in the head unit 24. The sprocket acts as a power takeoff for an electric motor located in the head unit 24.

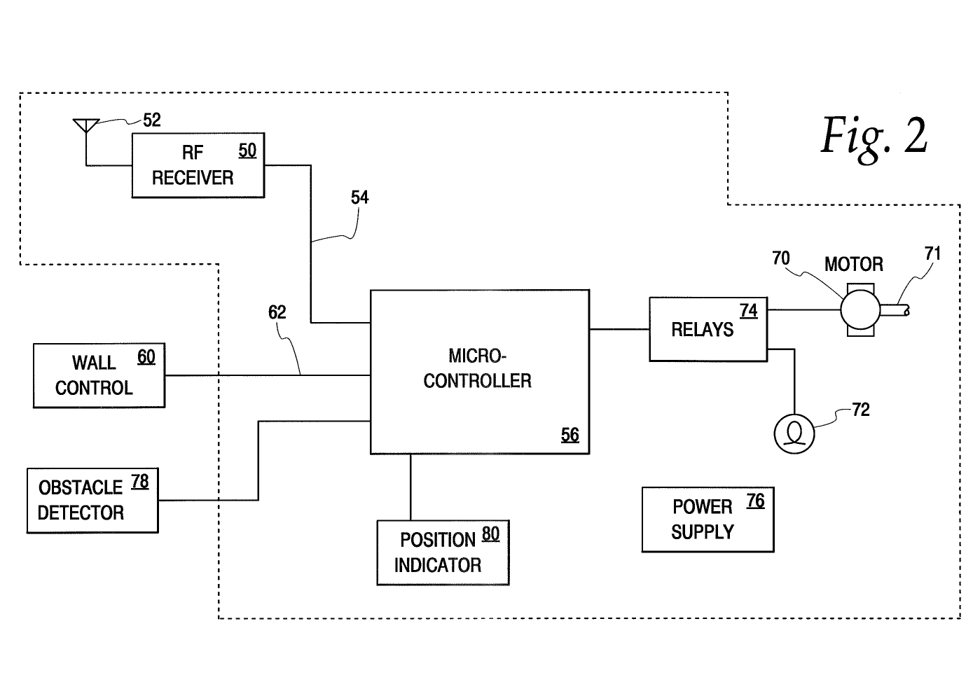

The head unit 24 includes a radio frequency receiver 50, as may best be seen in FIG. 2, having an antenna 52 associated with it for receiving coded radio frequency transmissions from one or more radio transmitters 53 which may include portable or keyfob transmitters or keypad transmitters. The radio receiver 50 is connected via a line 54 to a microcontroller 56 which interprets signals from the radio receiver 50 as code commands to control other portions of the garage door operator 10.

A wall control unit 60 communicates over a line 62 with the head unit microcontroller 56 to effect control of a garage door operator motor 70, and a light 72 via relay logic 74 connected to the microcontroller 56. The entire head unit 24 is powered from a power supply 76. In addition, the garage door operator 10 includes an obstacle detector 78 which optically or via an infrared pulsed beam detects when the garage door opening 22 is blocked and signals the microcontroller 56 of the blockage. The microcontroller 56 then causes a reversal or opening of the door 16. In addition, a position indicator 80 indicates to the head unit microcontroller 56, through at least part of the travel of the door 16, the door position so that the microcontroller 56 can control the close position and the open position of the door 16 accurately

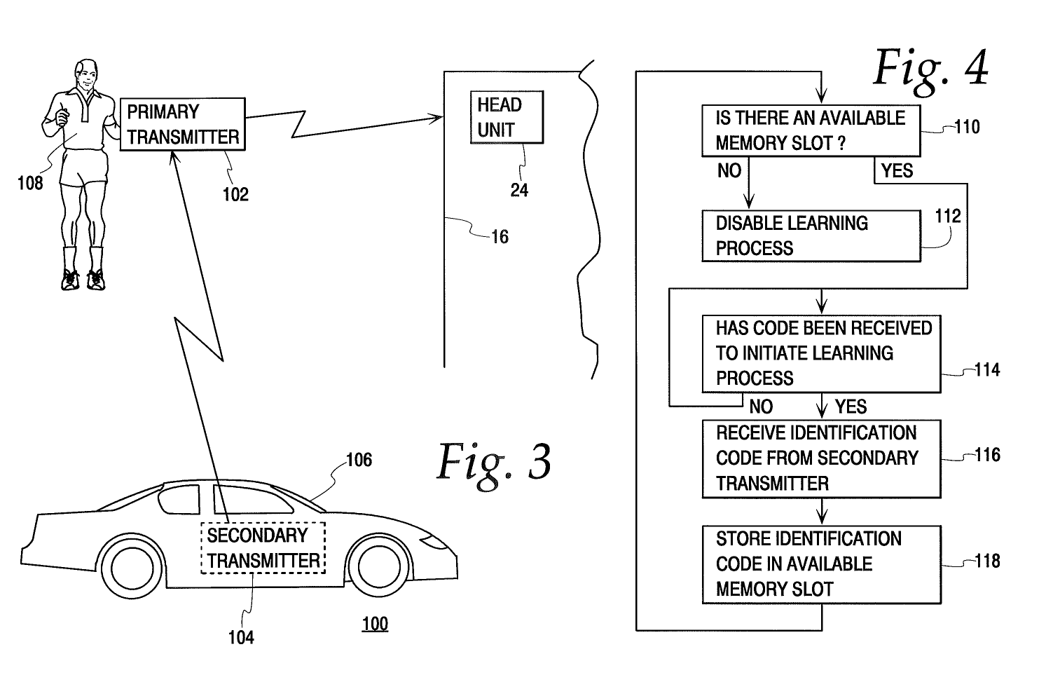

FIG. 3 illustrates a remote access system 100 according to at least one embodiment of the invention. As shown, the system 100 includes a primary transmitter 102 and a secondary transmitter 104. The secondary transmitter 104 may be placed within a vehicle 106 and may periodically broadcast an identification signal. The vehicle 106 may be periodically stored within a garage. To gain access to the garage remotely, an RF signal is transmitted to the head unit 24 which then causes the garage door 16 to open and close, as discussed above with respect to FIGS. 1 and 2.

The primary transmitter 102 is utilized by a user 108. The ability of the primary transmitter 102 to function when it is distant from the vehicle 106 in which it normally used is, however, removed. In other words, if the primary transmitter 102 is too far away from the vehicle 106, the primary transmitter 102 will not function to transmit an RF signal to the head unit 24 of the garage door opener to cause a garage door to open and close. For example, the optimal distance may be 10-30 feet depending on the embodiment. This distance restriction is implemented for safety purposes so that in the event that, for example, the primary transmitter 102 is stolen or lost, it cannot be used to cause the garage door opener 10 to open the garage door 16 by a third party. Because it is known that the primary transmitter 102 will normally be used by someone either within or near the vehicle 106, this restriction is made to prevent unauthorized usage.

In order to control whether the primary transmitter 102 may be utilized to cause the head unit to open or close the garage door 16, the second transmitter 104 is utilized to broadcast an identification signal that is to be received by the primary transmitter 102. The identification signal may be a rolling or fixed code transmitted at a predictable rate by the second transmitter 104. If the primary transmitter 102 receives the identification signal from the secondary transmitter 104, it is subsequently allowed to transmit an RF signal to the garage door opener to open the garage door 16. In some embodiments, the primary transmitter 102 cannot transmit an RF signal to the garage door opener unless it has received the identification signal within a predetermined time period. For example, there may be a time limitation such that the primary transmitter 102 can only transmit an RF signal to the garage door opener 10 to perform certain functions within 60 seconds of receiving the identification signal from the secondary transmitter 104.

In other embodiments, the primary transmitter 102 can still transmit the RF signal regardless of whether the identification signal has been received from the secondary transmitter 104. However, in order to operate, the garage door operator 10 would need to receive a certain code from the primary transmitter 102. This code is received by the primary transmitter 102 via the identification signal transmitted by the secondary transmitter 104.

In this embodiment, the secondary transmitter 104 is located with the vehicle 106. For example, it may be stored separately from the primary transmitter 102, for example, in a glove box, on visor, or anywhere else in the vehicle 106. In some embodiments, the secondary transmitter 104 is permanently fixed in the vehicle 106. In other embodiments, the secondary transmitter 104 is movable. In embodiments where the secondary transmitter 106 is fixed inside the vehicle 106, the secondary transmitter 104 may be mounted onto the dashboard or to an arm rest or fixedly mounted at any other suitable place in the vehicle 106. In some embodiments, an RF signal must be transmitted to the garage door opener 10 within a predetermined time limit (such as 60 seconds) or the primary transmitter 102 will wait until it receives a new identification signal from the secondary transmitter 104 prior to transmitting the RF signal to the garage door opener 10.

The primary transmitter 102 is associated with the vehicle 106 to provide heightened security. In order for the use of the secondary transmitter 102 to provide additional security over current RF transmitters, there has to be a way to associate the primary transmitter 102 with the vehicle to prevent a thief or other third party from using an unauthorized RF transmitter in the place of the authorized primary transmitter 102. For example, the primary transmitter 102 may require that a predetermined vehicle identification code be received in the identification signal from the secondary transmitter 104 prior to transmitting an RF signal to the garage door opener 10.

One way of making this association is for a manufacturer of the vehicle 106 to install the secondary transmitter 104. For example, the primary transmitter 102 may be pre-loaded with a unique code transmitted by the secondary transmitter 104, such that the primary transmitter 102 will only transmit to the garage door opener 10 in the event that this vehicle identification code is received in the identification signal from the secondary transmitter 104. The vehicle identification code may be stored in a memory within the primary transmitter 102 and a code received from the secondary transmitter 104 may be matched against the pre-stored vehicle identification code.

Alternatively, a learning process may be implemented by a user 108 to make the association between the primary transmitter 102 and the vehicle 106. For example, the secondary transmitter 104 may be sold and/or manufactured separately from the primary transmitter 102. In the event that the user 108 has the secondary transmitter 104 installed within the vehicle 106, the user 108 may use the primary transmitter 102 to initiate the learning process. For safety purposes, the primary transmitter 102 may have a limitation on the number of times a code may be learned from the secondary transmitter 104. For example, the primary transmitter 102 may come with three memory slots, and the user 108 may cause the primary transmitter 102 to learn three vehicle identification codes, one of which will be stored in each of the three memory slots. This would allow a single primary transmitter 102 to be used in three different vehicles, each of which has a secondary transmitter 104 that transmits a different vehicle identification code. However, after the three memory slots have been used, the primary transmitter 102 is not able to learn any new codes. Accordingly, if the user 108 wants to associate the primary transmitter 102 with a fourth vehicle, another primary transmitter 102 would have to be purchased for use with the fourth vehicle. The limitation on the number of times a vehicle identification code may be learned prevents a thief from using an RF transmitter pre-loaded with thousands of codes to circumvent the additional security provided by use of the second transmitter 104.

To prevent the user 108 from accidentally/inadvertently causing the primary transmitter 102 to enter into the learning process, additional safeguards may be implemented. For example, in the event that the primary transmitter 102 includes a keypad, the user 108 may be required to enter a unique code or some other type of password via the keypad in order to enter into the learning process. Alternatively, the user 108 may be required to depress certain designated buttons on the primary transmitter 102 for a specified amount of time (such as a period of 7.5 seconds) in order to enter into the learning process.

FIG. 4 illustrates a learning process for associating the primary transmitter 102 with the vehicle 106 according to at least one embodiment of the invention. First, at operation 110 a determination is made as to whether there is an available memory slot in which to store an identification code corresponding to the vehicle or the secondary transmitter 104. If “no,” processing proceeds to operation 112 where the learning process is disabled. If “yes,” on the other hand, processing proceeds to operation 114 where a determination is made as to whether a learning process code has been received to initiate the learning process. As discussed above, the learning process code may be a password or other code entered by the user 108 via a keypad or other buttons or switches on the primary transmitter 102. If “no,” at operation 114, processing remains at operation until the code is received. If “yes,” at operation 114, processing proceeds to operation 116 where a vehicle identification code is received from the secondary transmitter 104. Finally, at operation 118, the vehicle identification code is stored in an available memory slot, and then processing returns to operation 110.

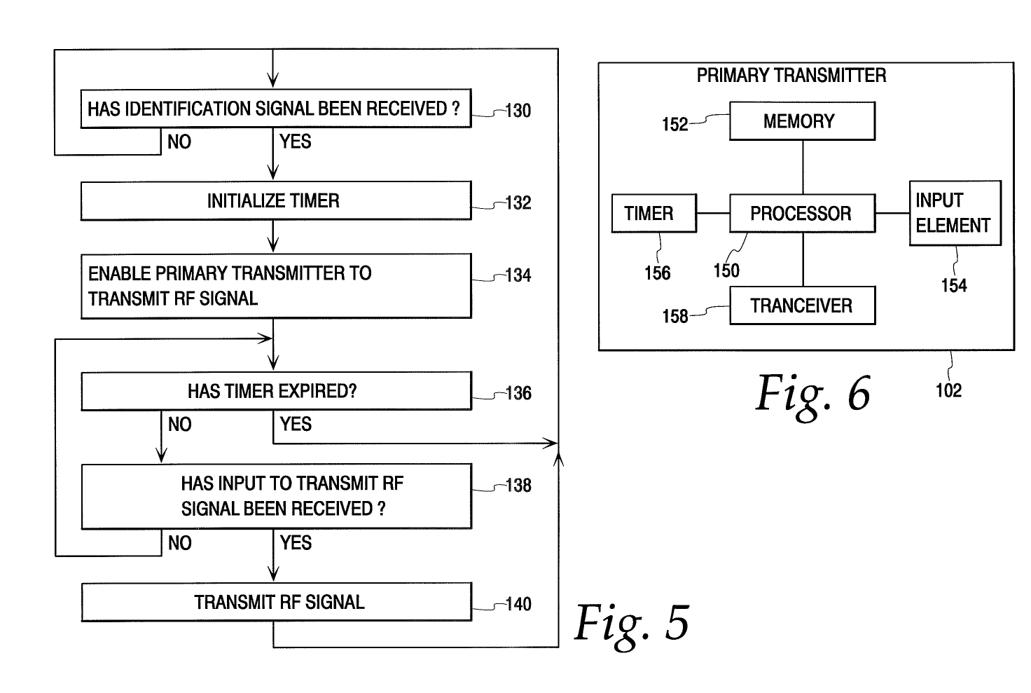

FIG. 5 illustrates a method of utilizing a secondary transmitter 104 to provide an identification signal to a primary transmitter 102 to transmit RF signals to a garage door opener 10 according to at least one embodiment of the invention. First, at operation 130, a determination is made by the primary transmitter 102 as to whether the identification signal has been received from the secondary transmitter 104. The identification signal may include a transmission of the vehicle identification code, and the proper vehicle identification code must be received in order to proceed to the next operation of FIG. 5.

Next, at operation 132, a timer within the primary transmitter 102 is initialized. For example, the timer may be initialized to 60 seconds. The timer is used to limit a time interval between when the identification signal is received and an RF signal may be transmitted to the garage door opener 10. Next, at operation 134, the primary transmitter 102 is enabled to transmit the RF signal to the garage door opener 10. At operation 136, a determination is made as to whether the timer has expired. If “no,” processing proceeds to operation 138. If “yes,” on the other hand, processing returns to operation 130 and the primary transmitter 102 waits until the next identification signal is received. At operation 138, a determination is made as to whether an input is received to transmit the RF signal to the garage door opener 10. The input may comprise a closing or opening of a switch or some other signal generated in response to, for example, a button on the primary transmitter 102 being depressed. If, at operation 138, no such input has been received, processing returns to operation 136. If, however, an input has been received, processing proceeds to operation 140 at which point the RF signal is transmitted. Finally, processing returns to operation 130.

FIG. 6 illustrates a primary transmitter 102 according to at least one embodiment of the invention. As shown, the primary transmitter 102 includes a processor 150 and may include other elements such as a memory 152, an input element 154, a timer 156, and a transceiver 158. The memory 152 may be utilized to store code to be executed by the processor 150. The memory 152 may also store the vehicle identification code, as discussed above with respect to FIG. 4. The input element 154 may include a depressible button or other element for receiving an input from a user to transmit an RF signal to the garage door opener to open or close the garage door 16.

FIG. 7 illustrates a remote access system 200 according to at least one embodiment of the invention. The remote access system 200 is similar to the remote access system 100 of FIG. 3 except that instead of including a secondary transmitter 102 to broadcast the identification signal, the remote access system 200 of FIG. 7 includes an RFID device 204 to transmit the identification signal.

The RFID device 204 may be stored within an automobile or near some other device where it will typically be used. A user 208 may hold the primary transmitter 202. When the user 208 desires access to the garage, the user may depress a button on the primary transmitter 202. The primary transmitter 202 may then broadcast an RF signal to request an identification signal from the RFID device 204. In response to receiving the RF signal, the RFID device 204 may transmit the identification signal to the primary transmitter 202. In some embodiments, the RFID device 204 is in communication with a transmitter or transceiver and utilizes power from the received signal to transmit the identification signal. In other embodiments, the transmitter in the RFID device 204 receives power from a battery or other power source to transmit the identification signal.

As with the secondary transmitter 104 of FIG. 3, the RFID device 204 may be placed within the vehicle 206. The ability of the primary transmitter 202 to function when it is distant from the vehicle 206 in which it normally used is, however, removed. In other words, if the primary transmitter 202 is too far away from the vehicle 206, the primary transmitter 202 will not be able to receive the identification signal and will not be able to function to transmit the RF signal to the head unit 24 of the garage door opener 10 to cause the garage door 16 to open and close. This distance restriction is implemented for safety purposes so that in the event that, for example, the primary transmitter 202 is stolen or lost, it cannot be used to cause the garage door opener 10 to open the garage door 16 by a third party. Because it is known the primary transmitter 202 will normally be used by someone either within or near the vehicle 206, this restriction is made and may be used to prevent unauthorized usage. As a result of use of RFID technology, the RFID device 204 may be designed to consume a minimal amount of power.

The identification signal transmitted from the RFID device 204 to the primary transmitter 202 may be a rolling or fixed code transmitted at a predictable rate. If the primary transmitter 202 receives the identification signal from the RFID device 204, it is subsequently allowed to transmit an RF signal to the garage door opener 10 to open the garage door 16. In some embodiments, the primary transmitter 202 cannot transmit an RF signal to the garage door opener 10 unless it has received the identification signal within a predetermined time period. For example, there may be a time limitation such that the primary transmitter 202 can only transmit an RF signal to the garage door opener 10 to perform certain functions within 60 seconds of receiving the identification signal from the RFID device 204.

The primary transmitter 202 is associated with the vehicle 206 to provide heightened security. For example, the primary transmitter 202 may require that a predetermined vehicle identification code be received in the identification signal from the secondary transmitter 204 prior to transmitting an RF signal to the garage door opener 10. This vehicle identification code may be pre-stored or determined via a learning process similar to, or the same as, the process discussed above wit respect to FIG. 4.

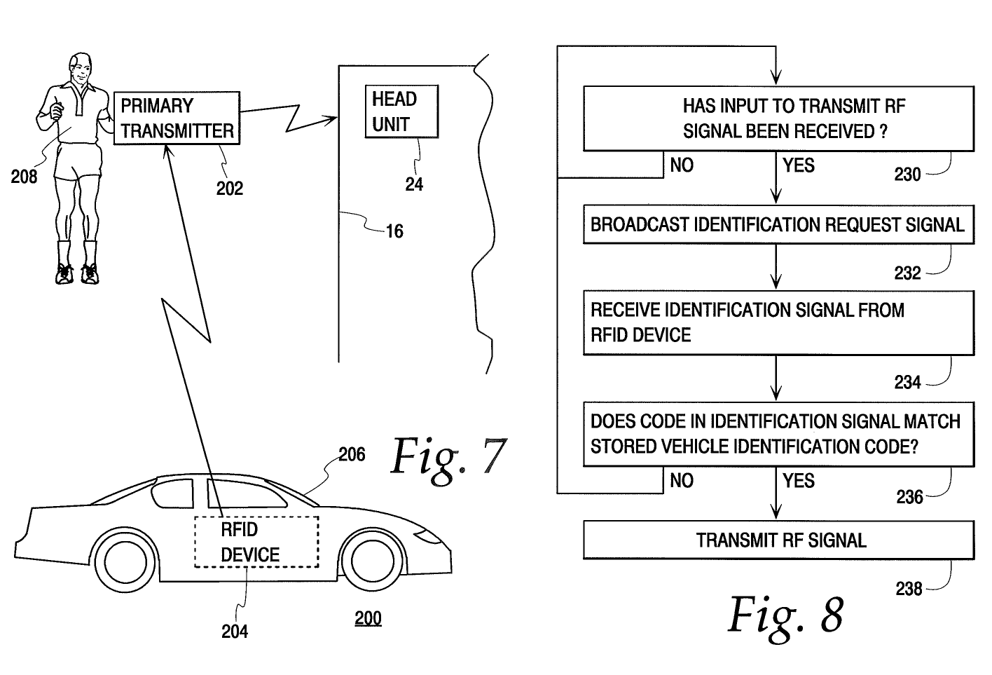

FIG. 8 illustrates a method of utilizing the primary transmitter 202 according at least one embodiment of the invention. First, at operation 230, a determination is made as to whether an input has been received to transmit an RF signal to the garage door opener 10. The input may comprise a closing or opening of a switch or some other signal generated in response to, for example, a button on the primary transmitter 202 being depressed. If, at operation 230, no such input has been received, processing remains at operation 230. If, however, an input has been received, processing proceeds to operation 232 at which point an identification request signal is broadcast by the primary transmitter 202. In the event that the RFID device 204 receives the identification request signal, the RFID device 204 may, at operation 234, transmit the identification signal that may then be received by the primary transmitter 202. Next, at operation 236, a determination is made as to whether a code in the identification signal matches a vehicle identification code stored in the primary transmitter 202. If “no,” processing returns to operation 230. If “yes,” on the other hand, processing proceeds to operation 238. Finally, at operation 238, the RF signal is transmitted to the garage door opener 10.

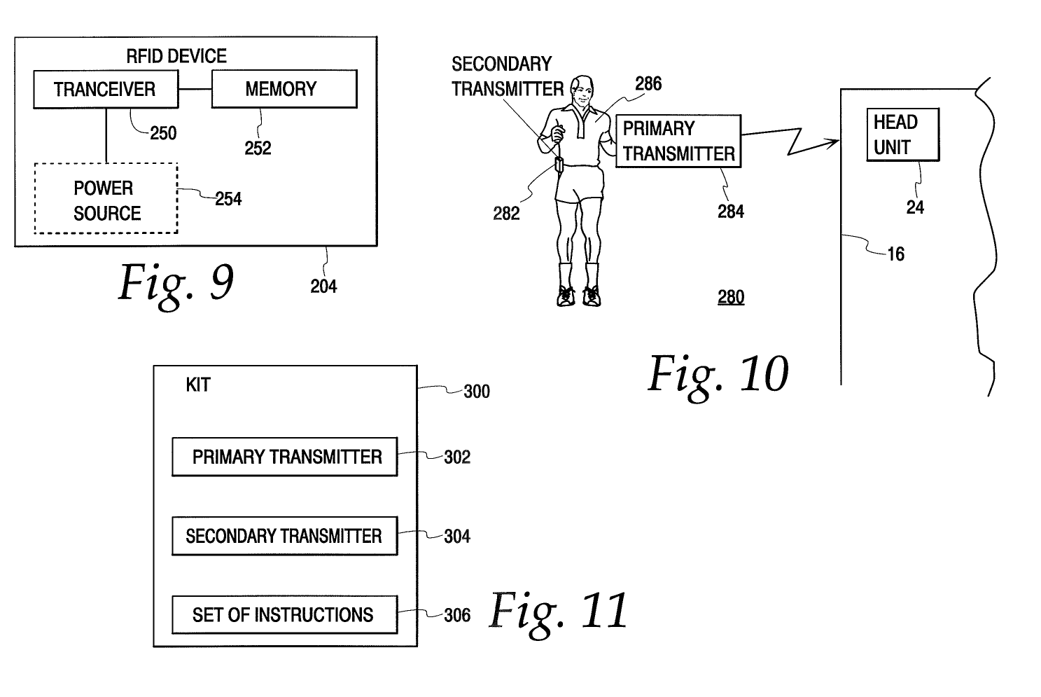

The primary transmitter 202 may include some, or all of elements as were described above with respect to the primary transmitter 102 of FIG. 6. FIG. 9 illustrates the RFID device 204 according to at least one embodiment of the invention. As shown, the RFID device 204 includes a transceiver 250 and a memory 252. The RFID device 204 may also optionally include a power source 254 to provide power to the transceiver 250. The transceiver 250 may receive the identification request signal from the primary transmitter 202 and transmit the identification signal to the primary transmitter 202.

FIG. 10 illustrates a system 280 for utilizing a secondary transmitter 282 to provide an identification signal to a primary transmitter 284 to transmit RF signals to a garage door opener 10 according to at least one embodiment of the invention. In this system, instead of being fixed inside a vehicle, as in FIGS. 3 and 7, the secondary transmitter 282 may instead be portable. For example, the secondary transmitter 282 may comprise a small transmitter. In some embodiments, the secondary transmitter 282 may be made small enough to fit within a user's 286 wallet or be coupled to the user's keychain, watch, or cell phone, to name a few examples. The secondary transmitter may comprise any object capable of transmitting an identification signal and capable of being moved. To provide the best security, the secondary transmitter 282 may be coupled to something that an authorized user 286 would normally have with him/her. The secondary transmitter 282 may comprise an RFID device or a communication device that periodically broadcasts the identification signal.

FIG. 11 illustrates a kit 300 according to at least one embodiment of the invention. The kit 300 may be sold to a user in, for example, a hardware or department store. The kit 300 includes a primary transmitter 302 and a secondary transmitter 304, such as those discussed above with respect to FIGS. 3-9. Alternatively, the kit 300 may include multiple primary transmitters 302 and/or secondary transmitters 304. The secondary transmitters 304 may be the type that are mounted in vehicles or the type that are portable outside of a vehicle. The kit 300 also includes a set of instructions 306. The set of instructions 306 may include assembly instructions regarding how to use the primary transmitter 302 and the secondary transmitter 304.

Pursuant to the various embodiments described above, an RF transmitter is provided for controlling operation of a barrier movement operator, such as a garage door opener. The ability of the RF transmitter to function when it is distant from an identification transmitter located near where the RF transmitter is normally used is, however, limited.

A secondary RF transmitter may be placed within the vehicle or on the user's key chain or in the user's pocket, for example, and may periodically broadcast an identification signal. If the primary RF transmitter receives the identification signal, it is subsequently allowed to transmit an RF signal to the garage door opener to open or close the garage door. In some embodiments, the primary RF transmitter cannot transmit an RF signal unless it has received the identification signal within a predetermined time period. In other embodiments, the primary RF transmitter can still transmit the RF signal regardless of whether the identification signal has been received from the secondary transmitter. However, in order to operate, the garage door operator would need to receive a certain code from the primary RF transmitter. This code may be received from the secondary RF transmitter via the identification signal. In this embodiment, the secondary RF transmitter is located with the vehicle. The identification signal may include a rolling or fixed code. In some embodiments, an RF signal must be transmitted to the garage door opener within a predetermined time limit (such as 60 seconds) or the primary RF transmitted will wait until it receives a new identification signal from the secondary transmitter prior to transmitting the RF signal to the garage door opener.

The primary RF transmitter may be associated with a specific vehicle. A learning process may be implemented to make this association. During the learning process, a vehicle identification code may be received from the secondary transmitter and stored in a memory of the primary transmitter. After the learning process is completed, the primary transmitter may be controlled so that an RF signal is transmitted to the garage door opener only after a signal containing the same vehicle identification code has been received from the secondary transmitter.

In another embodiment, a Radio Frequency Identification (“RFID”) device may be utilized. In such embodiments, instead of intermittently broadcasting the identification signal at certain intervals, the identification signal may instead be transmitted via RFID technology. For example, a user may depress a button on the RF transmitter, causing an RF signal to be transmitted to the RFID device. Upon receiving the RF signal, the RFID device transmits the identification signal to the RF transmitter. In some embodiments, the RFID tag is in communication with a transmitter and utilizes power from the received signal to transmit the identification signal. In other embodiments, the transmitter receives power from a battery or other power source to transmit the identification signal.

Accordingly, the embodiments described above provide security to the owner of a garage door opener by removing the ability for a transmitter to function when it is distant from a vehicle in which it is normally used. By adding a secondary transmitter within the vehicle and requiring the primary transmitter to receive an identification signal from the secondary transmitter, the primary transmitter would have knowledge that it is close enough to the vehicle in order to activate the garage door opener to perform various functions.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for commanding a movable barrier operator to control movement of a movable barrier and perform additional movable barrier functions, comprising:
receiving a learning mode indication to implement a learning mode, the learning mode comprising receiving and storing a vehicle identification code corresponding to a specific vehicle;
receiving a request to transmit a control signal to the movable barrier operator to command the movable barrier operator to perform at least one of the additional movable barrier functions;
detecting an identification signal wirelessly transmitted at a predetermined rate from a predetermined device;
determining whether the identification signal comprises a code matching the vehicle identification code; and
transmitting the control signal to the movable barrier operator to command the movable barrier operator to perform the at least one of the additional movable barrier functions in response to the receiving, the detecting, and the determining that the identification signal comprises the code matching the vehicle identification code.

2. The method of claim 1, wherein the predetermined device is a transmitter located inside of the specific vehicle.

3. The method of claim 1, wherein the predetermined device is portable outside of the specific vehicle.

4. The method of claim 1, wherein the identification signal comprises at least one of a rolling code and a fixed code.

5. The method of claim 1, further comprising determining a time interval between the receiving and the detecting, and only performing the transmitting in response to the time interval being no greater than a predetermined threshold time interval.

6. The method of claim 1, further comprising transmitting an identification request signal to the predetermined device.

7. The method of claim 6, wherein the predetermined device transmits the identification signal in response to receiving the identification request signal.

8. The method of claim 6, wherein the predetermined device comprises a Radio Frequency Identification (“RFID”) device.

9. The method of claim 1, wherein the learning mode indication comprises at least one of an entry of a predetermined code via a keypad of the primary transmitter, and a pressing of at least one predetermined button on the primary transmitter for at least a predetermined length of time.

10. A system for commanding a movable barrier operator to control movement of a movable barrier and perform additional movable barrier functions, comprising:
an identification transmitter to wirelessly transmit an identification signal, wherein the identification signal comprises a code; and
a primary transmitter to store at least one vehicle identification code corresponding to a specific vehicle, receive a request to transmit a wireless control signal to the movable barrier operator to command the movable barrier operator to perform the at least one of the additional movable barrier functions, and to transmit the wireless control signal in response to receiving the request, detecting the identification signal, and determining that the code of the identification signal matches the at least one vehicle identification code.

11. The system of claim 10, wherein the primary transmitter is adapted to receive a learning mode indication to implement a learning mode, the learning mode comprising receiving and storing the at least one vehicle identification code in a memory of the primary transmitter.

12. The system of claim 10, wherein the identification transmitter is located inside the specific vehicle.

13. The system of claim 10, wherein the identification transmitter is portable outside of the specific vehicle.

14. The system of claim 10, wherein the identification transmitter comprises a Radio Frequency Identification (“RFID”) device.

15. The system of claim 14, wherein the RFID device is in communication with a power source.

16. The system of claim 14, wherein the RFID device includes a transceiver to receive an identification request signal and transmit the identification signal in response to receiving the identification request signal.

17. The system of claim 16, wherein the primary transmitter includes a primary transceiver to transmit the identification request signal.

18. The system of claim 10, wherein the primary transmitter comprises a detection element to detect at least one of a rolling code and a fixed code in the identification signal.

19. The system of claim 10, wherein the primary transmitter comprises a processing element to determine a time interval between the receiving and the detecting, and only permit the transmitting of the wireless control signal in response to the time interval being no greater than a predetermined threshold time interval.

20. A primary transmitter for commanding a movable barrier operator to control movement of a movable barrier and perform additional movable barrier functions, comprising:
an input element to receive an input from a user to command the movable barrier operator;
a memory to store at least one vehicle identification code corresponding to a specific vehicle;
a transceiver to transmit a wireless control signal to the movable barrier operator to command the movable barrier operator to perform the at least one of the additional movable barrier functions in response to detecting a wireless identification signal transmitted from a predetermined device, and in response to determining that the wireless identification signal comprises a code matching the at least one vehicle identification code; and
a processor to control operation of the transceiver in response to receiving the input from the input element.

21. The primary transmitter of claim 20, wherein the primary transmitter is adapted to receive a learning mode indication to implement a learning mode, the learning mode comprising receiving and storing the at least one vehicle identification code in the memory.

22. The primary transmitter of claim 20, wherein the processor is adapted to determine a time interval between the a time when the wireless identification signal receiving and the detecting, and only permit the transmitting of the wireless control signal in response to the time interval being no greater than a predetermined threshold time interval.

23. The primary transmitter of claim 20, wherein the transmitter is adapted to transmit an identification request signal to the predetermined device.

24. The primary transmitter of claim 23, wherein the predetermined device is a Radio Frequency Identification (“RFID”) device.

25. The primary transmitter of claim 20, wherein the input element comprises at least one movable button.

26. A kit comprising:
an identification transmitter to wirelessly transmit an identification signal, wherein the identification signal comprises a code;
a primary transmitter to store at least one vehicle identification code corresponding to a specific vehicle, receive a request to transmit a wireless control signal to a movable barrier operator to command the movable barrier operator to perform the at least one movable barrier function, and to transmit a wireless control signal in response to receiving the request, detecting the identification signal, and determining that the code of the identification signal matches the at least one vehicle identification code;
a set of instructions for using the identification transmitter and the primary transmitter.
